(19) United States
(12) Patent Application Publication
(10) Pub. No.: US 2018/0271209 A1
(43) Pub. Date: Sep. 27, 2018

(54) VIBRATING MASSAGER GARMENT

(71) Applicant: Sanad Zahrieh, Brooklyn, NY (US)

(72) Inventor: Sanad Zahrieh, Brooklyn, NY (US)

(21) Appl. No.: 15/952,425

(22) Filed: Apr. 13, 2018

Related U.S. Application Data
(63) Continuation-in-part of application No. 15/837,906, filed on Dec. 11, 2017.
Application No. 15/837,906 is a continuation of application No. 14/737,639, filed on Jun. 12, 2015, now Pat. No. 9,839,258.

(51) Int. Cl. A43B 7/14; A43B 7/02; G06F 19/00; A43B 3/00; A43B 13/04; A43B 7/08; A43B 13/36; A43B 13/12; A43B 1/00; A43B 13/14; A43C 11/14

(52) U.S. Cl. CPC A43B 7/146; A61H 7/004; A61H 2205/125; A43B 7/02; G06F 19/00; A43B 3/001; A43B 13/04; A43B 3/0005; A43B 7/085; A43B 13/36; A43B 13/12; A43B 1/0054; A43B 13/14; A43C 11/14; A61H 2201/165; A61H 2201/10; A61H 2201/5005; A61H 2201/164; A61H 2201/0107; A61H 2205/065

(57) ABSTRACT

A massaging compression garment, comprising a body that includes a stretchy textile and a plurality of coin vibration motors coupled to the inside surface of the garment body. A battery is electrically coupled to the coin vibration motors. A power switch controls the flow of power from the battery to the coin vibration motors to cause them to vibrate.

This application is a CIP of U.S. application Ser. No. 15/837,906, filed Dec. 11, 2017, which is a continuation of U.S. application Ser. No. 14/737,639, filed Jun. 12, 2015, now U.S. Pat. No. 9,839,258, all of which are hereby incorporated by reference in their entireties as if fully set forth herein.

### FIELD OF THE EMBODIMENTS

The field of embodiments of this invention relates to wearable garments that provide therapeutic vibration to the wearer.

### BACKGROUND OF THE EMBODIMENTS

The foot is one of the most complex portions of the human body and due in part to that fact, foot problems are pervasive throughout today's society. Affecting various parts of the foot's 26 bones, 42 muscles, 33 joints, and more than 50 ligaments and tendons, a wide variety of foot problems exist. The foot has many pressure points, each of which is related to a different part of the body.

This foot-body part relationship is part of the larger reflexology movement. While expert disagree on the finer points of how reflexology works, the general consensus is that certain parts of the foot, when stimulated, can generate relief in other parts of the body. Put simply, reflexology is an art of natural healing based on the principle that there are pressure points reflexes) in the feet, hands and ears, and each point (zone) corresponds to every part, gland and organ of the body. Through the targeted stimulation of these zones relieves tension, one can improve their circulation and encourage the natural function of various areas of the body.

These directed massage techniques can have a wide variety of benefits. As stated, through the calculated manipulation of these pressure points, one can induce the relief of back pain as well as the relief of headaches. Further, through the proper stimulation of these zones, it has been shown that a person may soothe their eyes, ears, trapezius, long bronchus, shoulders, liver, gall bladder, kidneys, urethral canal, ascending colon, small intestine, knees, vermiform appendix, angiomatosis, paranasal cavity, left cerebrum, right cerebrum, nose, pituitary gland, neck, lymph, parathyroid glands, stomach, renal glands, pancreas, duodenum, transverse colon, bladder, heart, genitalia, and much more. Thus the present invention has wide-applicability in treating various ailments.

However, many people struggle to find the time to engage in these treatments, particularly because they require a user to remain stationary for extended periods of time.

Thus, there is a need for a device that allows for a user to enjoy directed massages while on-the-go. The present invention and its embodiments meet and exceed this objective.

### REVIEW OF RELATED TECHNOLOGY

U.S. Pat. No. 5,913,838 teaches a vibrating foot massage insole apparatus comprising an insole means having an upper portion, a lower portion, a heel portion and a toe portion; vibrator means mounted on said lower portion of said insole means; power supply means; battery means mounted in said power supply means; control means mounted in said power supply means; and electrical connection means with said electrical connection means connecting said vibrator means, said battery means, said power supply means and said control means, wherein said electrical connection means comprises electrical cable means and further comprising wire retracting means disposed on said power supply means for retracting said electrical cable means.

U.S. Pat. No. 7,603,797 teaches a portable shoe comprising a shoe body and a toe-separating massager, wherein the shoe body having a shoe sole and a vamp, and a front end of the top surface of the shoe sole is formed with a containing groove for fixing the toe-separating massager. The toe-separating massager is disposed with a plurality of separating posts and engaging grooves on the top surface thereof that are arranged staggered, and each engaging groove is engaged with a rotatable biochemical ball. By such arrangements, when the user puts on the shoe, the present invention can rectify the positions of the toes and can massage the toes by the bioelectricity discharged by the biochemical balls.

U.S. Pat. No. 6,258,048 teaches an electric foot massaging assembly wherein a flexible slipper is positioned on the slipper mount with an opening formed in an upper extent thereof for receiving a foot therein. A roller assembly includes a plurality of rollers mounted on the slipper mount for massaging a foot within the slipper. A motor is included for rotating the rollers.

CN 202364931 teaches a foot massage shoes, including an insole and sole massage room set up a drug cushion, cushion drugs made from breathable material coated with herbs, the sole or set the battery pack on the vamp, the battery pack with a vibrator connected by wires, a switch button to connect and control the vibrator switch through the wire and battery components.

CN 203087697 teaches an interchangeable soles slippers, including: slippers (I); wherein: slipper insoles (I) within (2), the insole (2) magnet (3); slippers (I) the lower part of Additional insole (4), the magnet attached within the insole (5).

WO2012/069553 and EP2782542 disclose a foot massager comprising a motor and a human foot receiver holding assembly comprising at least one human foot receiver for constraining at least one foot therein wherein the motor is provided for driving the human foot receivers such as to massage feet in the human foot receivers holding assembly, characterized in that the foot massager is provided with an eccentric block such that the motor, the eccentric block, the human foot receiver holding assembly and the human foot receiver are interconnected such that when driven by the motor the human foot receiver describes an elliptical translational movement such that the rotation axis of the elliptical translational movement intersects with the longitudinal direction of said human foot receiver and wherein the elliptical translational movement is a vibrating movement with a frequency between 35 and 50 Hz.

### SUMMARY OF THE EMBODIMENTS

A massaging compression garment, comprising a body that includes a stretchy textile and a plurality of coin vibration motors coupled to the inside surface of the garment body. A battery is electrically coupled to the coin vibration motors. A power switch controls the flow of power from the battery to the coin vibration motors to cause them to vibrate.

In various exemplary embodiments, the motors, battery, and power switch are removably coupled to the garment body. The motors and the inside surface of the garment can be configured and arranged so at least a portion of the motors are disposed at select locations to provide targeted stimulation on the wearer's body.

In exemplary embodiments, a plurality of sensors are coupled to the garment. The sensors may include proximity sensors arranged to provide 360 degree situational awareness to a wearer of the garment. A processor communicatively coupled to the sensors receives proximity data from the sensors, analyzes the data to determine range and direction to a sensed object, and sends signals to the motors to vibrate in accordance with a predetermined vibrational scheme to convey the range and direction information to the wearer of the garment.

In exemplary embodiments, one or more microphones can be communicatively coupled to the processor. The microphones can receive verbal audio signals that the processor analyzes and converts to text, and generates a message to be conveyed to the wearer of the garment. The processor conveys the message by causing the coin motors to vibrate in accordance with a code comprising vibrational patterns that represent textual symbols, such as Morse code or Braille. An embodiments, the microphone receives audio signals containing music, and the processor causes the coin motors to vibrate in a manner that conveys to the wearer of the garment a tactile experience based on the music.

It is to be understood that both the foregoing general description and the following detailed description are exemplary and explanatory and are intended to provide further explanation of the invention as claimed.

### BRIEF DESCRIPTION OF THE DRAWINGS

FIG. 1 is a side view of an embodiment of the present invention showing its separable nature.

FIG. 2 is another side view of an embodiment of the present invention.

FIG. 3 is a perspective view of an embodiment of bottom portion equipped with a complete custom sole of the present invention.

FIG. 4 is a perspective view of the interfacing sole of the present invention.

FIG. 5 is a rear view of an embodiment of the present invention.

FIG. 6 is a front view of an embodiment of the present invention.

FIG. 7 is a perspective view of the top of the custom sole of the present invention.

FIG. 8 is a perspective view of the top and bottom of the custom sole of the present invention.

FIG. 9 is a side view of an embodiment of the present invention, highlighting the detachable nature of the strap.

FIG. 10 is a bottom perspective view of the top portion and interfacing sole of the present invention.

FIGS. 11A and 11B illustrate an exemplary embodiment of a compression garment according to the disclosure.

### DETAILED DESCRIPTION OF ILLUSTRATIVE EMBODIMENTS

Embodiments of the present invention will now be described with reference to the drawings, in which identical elements are identified with the same reference numerals. These embodiments are provided by way of explanation of the present invention, which is not intended to be limited thereto. Those of ordinary skill in the relevant arts may appreciate upon reading the present specification and viewing the present drawings that various modifications and variations can be made thereto.

In a preferred embodiment, the present invention consists of a slipper that is equipped with at least one vibrating motor. It should be noted that a wide variety of motors at suitable for this purpose, the appropriateness of said motors being determined by the force of the vibration desired as well as the size of a user's foot.

The present invention consists of a slipper that is capable of massaging a user's feet that a user may also be used both indoors and outdoors. One benefit of this device is that many different combinations of vibrating motors exist allowing a user a wide range of customizability in how their foot is massaged. Additionally, these motors are readily substitutable and rearrangeable, making it easy to reconfigure the device.

The motors of the present invention are substituted or rearranged by first detaching the bottom portion. When removed, the bottom portion exposes the custom sole, having a top and bottom part. By replacing the custom sole and employing the plurality of lock-in pegs to reattach the top portion to the bottom portion, a user has effectively substituted one configuration of motors for an alternative configuration.

In a preferred embodiment, several micro coin cell motors are employed to generate the vibrations. It should be noted that in some embodiments, the top portion and bottom portion of the present invention are removable detachable. In these embodiments, the custom sole may be readily replaced with a custom sole of a similar or different configuration. In other embodiments, the top portion and bottom portion of the present invention are of a solitary construction. In these cases, a user would have to don a different embodiment of the present invention if they desired to stimulate a different area of their feet. It should be noted that while the components of the present invention are depicted as being of a particular shape, many shapes are suitable provided that the bottom portion, the custom sole, the interfacing sole, and the top portion are all shaped complimentarily to each other.

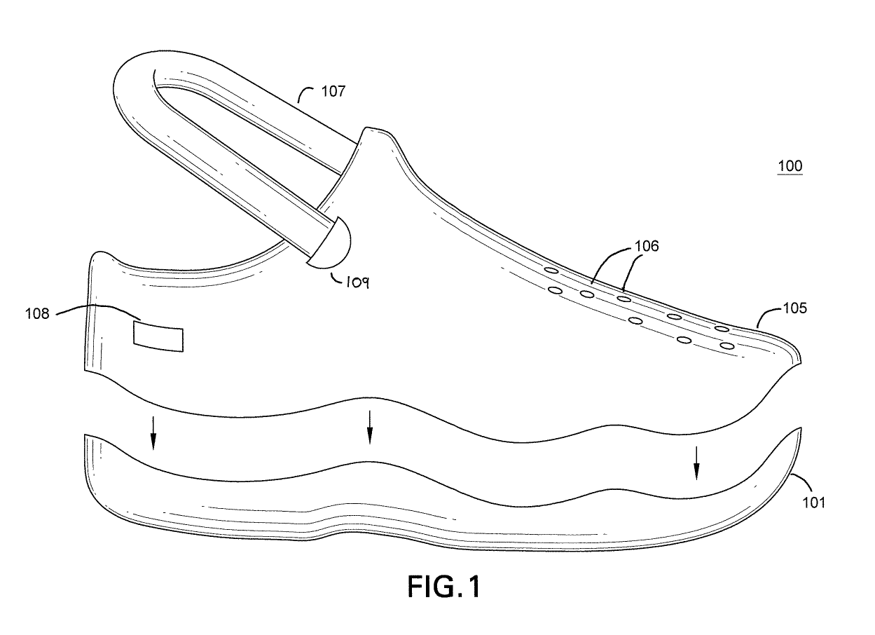

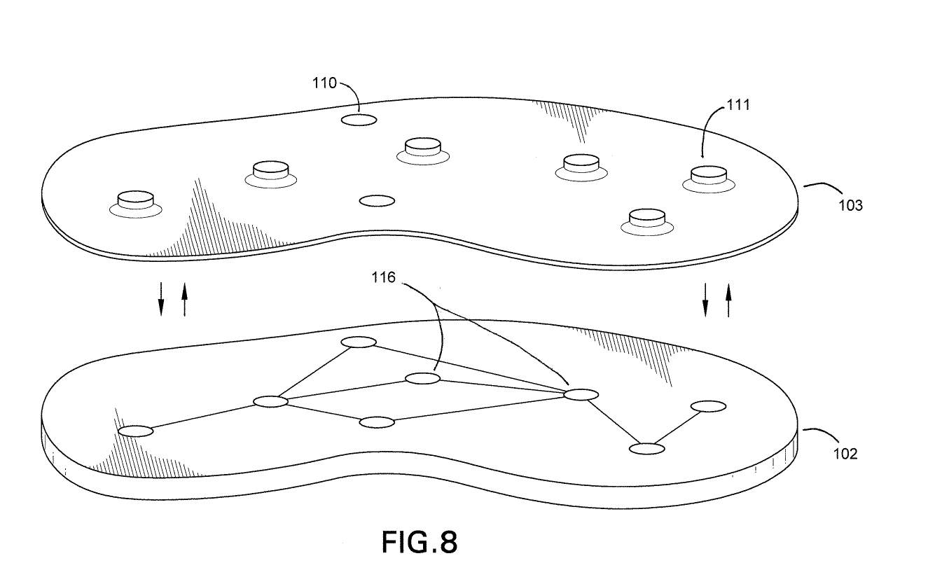

Referring to FIG. 1, a side view of an embodiment of the present invention showing its separable nature is provided for. In this figure, vibrating foot massager 100 is shown. Further, bottom portion 101, top portion 105, plurality of holes 106, strap 107, power switch 108, and connection mechanism 109 are also shown. This figure shows an embodiment of the present invention where the top portion 105 is removably detachable from bottom portion 101. This allows a user to easily switch out, as a single unit, top portion and bottom portion of custom sole 102 and 103 (See FIG. 8). In some embodiments, the present invention is not equipped with plurality of holes 106. While plurality of holes 106 provides additional ventilation, they are not necessary for the present invention to function. Power switch 108 allows a user to conveniently operate the present invention. This is of particular importance because many users of the present invention will likely be suffering from back pain and other ailments that limit their mobility. In a preferred embodiment, the present invention is equipped with a power source, contained within strap 107. Preferably, this power source will be a rechargeable electrochemical cell.

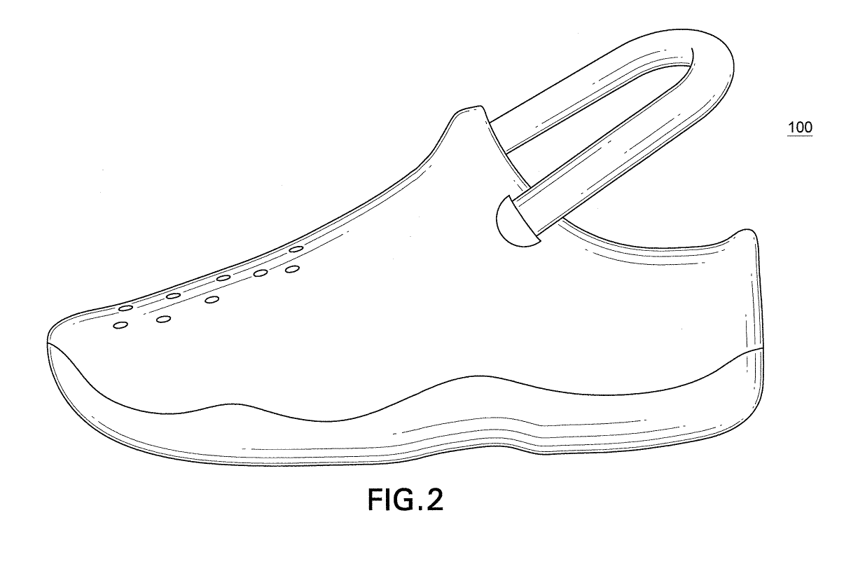

FIG. 2 is another side view of an embodiment of the present invention. It shows a solitary construction of vibrating foot massager 100. In another preferred embodiment, vibrating foot massager 100 is constructed substantially out of rubber.

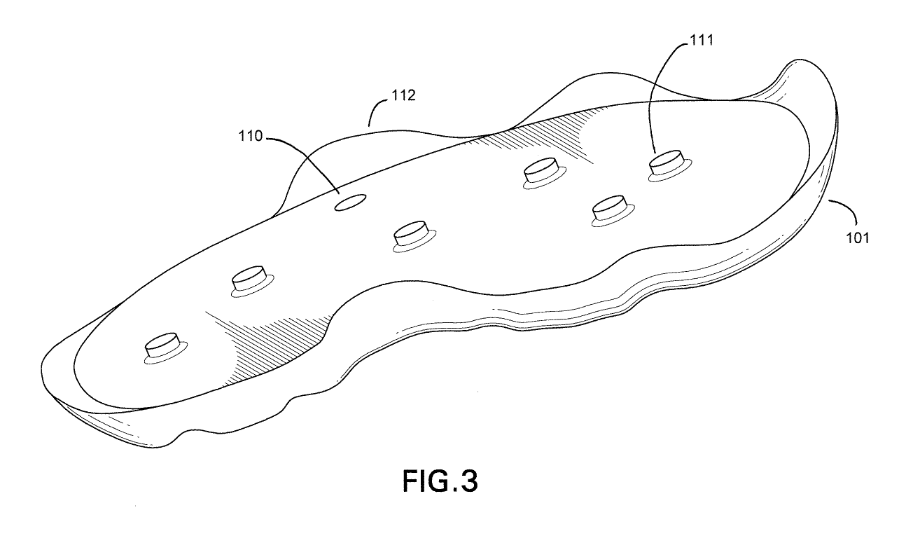

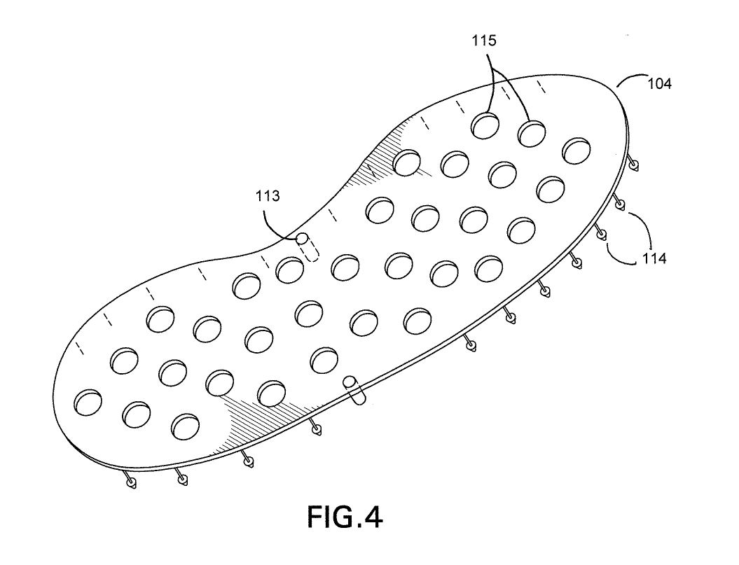

Turning to FIG. 3, a perspective view of an embodiment of bottom portion equipped with a complete custom sole of the present invention is provided for. Here, bottom portion 101, raised skirt 112, terminal slot 110, and plurality of raised bumps 111 are shown. Preferably, bottom portion 101 is constructed substantially out of rubber. In another preferred embodiment, bottom portion 101 is constructed out of a rubber foam. Plurality of raised bumps 111 are used to house plurality of motors 116 (See FIG. 8). While plurality of raised bumps 111 are shown in a particular configuration here, their configuration will vary based on the location of the plurality of motors 116 (See FIG. 8), and based on which zones a user is attempting to stimulate. Terminal slot 110 is used to receive at least one terminal 113 (See FIG. 4). Raised skirt 112 serves an important purpose. In one embodiment, the present invention creates a crease between top portion 105 (See FIG. 1) and bottom portion 101. This crease allows dirt and other materials to pass through the present invention, which is why in a preferred embodiment the present invention is equipped with raised skirt 112. There, raised skirt 112 prevents any materials passing through any gap that might form between bottom portion 101 and top portion 105 (See FIG. 1).

In a preferred embodiment, the complete custom sole and bottom portion 101 will be sold as a single unit. This packaging would allow a user to purchase a number of different bottom portion 101/complete custom sole combinations depending on what area of the body a user would like to stimulate.

Referring to FIG. 4, is a perspective view of the interfacing sole of the present invention is provided for. This figure shows interfacing sole 104, plurality of motor slots 115, at least one terminal 113, and plurality of pegs 114. Interfacing sole attaches to the bottom-most part of top portion 105 (See FIG. 1). It is equipped with plurality of motor slots 115 to accommodate all of the different configurations that top and bottom portion of custom sole 102 and 103 may take. Accordingly, while it is possible that each of plurality of motor slots 115 will be used, there exist many embodiments where only a small fraction of plurality of motor slots 115 will be utilized at a time. At least one terminal 113 will be used as a conduit from the power source of the present invention, wherein said conduit is mediated by power switch 108 (See FIG. 1). A plurality of pegs are used to secure top portion 105 to bottom portion 101 (See FIG. 1). Preferably, these pegs are lock-in pegs, which will provide sufficient grip to allow a user to walk around wearing the present invention without worrying about top portion 105 and bottom portion 101 coming apart. In a preferred embodiment, interfacing sole and top portion 105 (See FIG. 1) are permanently affixed to each other. In another embodiment, plurality of pegs will be replaced by a plurality of magnets, such that the top and bottom portion may be attached and removed with ease.

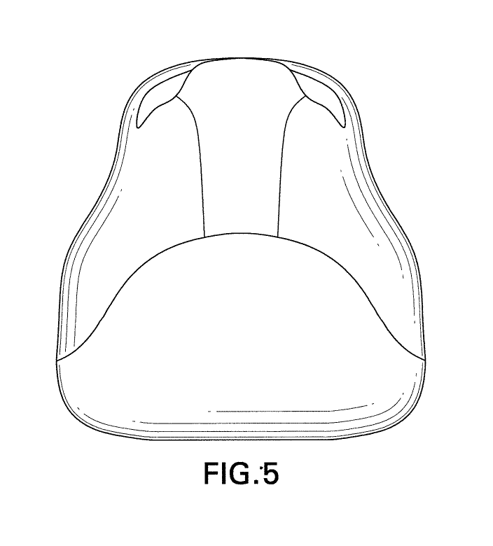

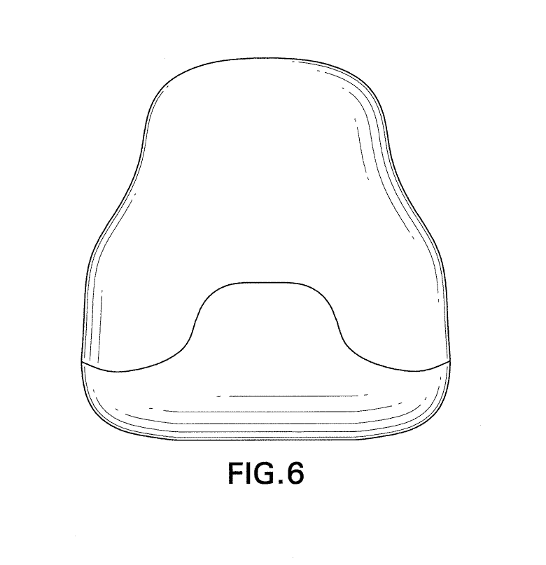

FIG. 5 is a rear view of an embodiment of the present invention and FIG. 6 is a front view of an embodiment of the present invention.

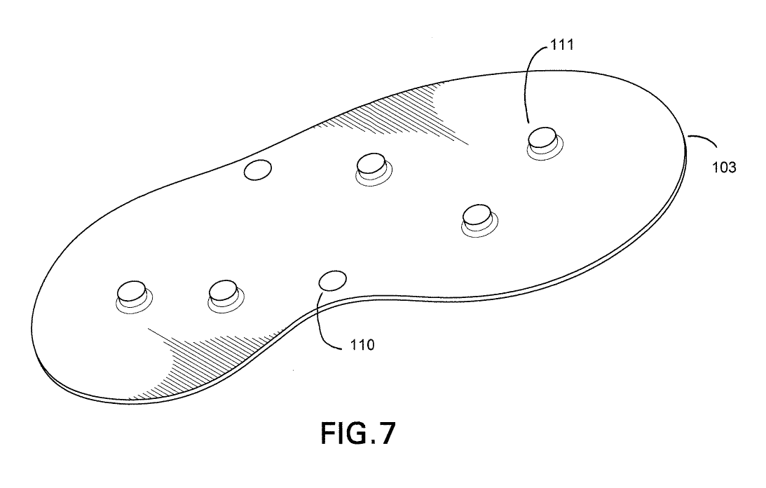

In FIG. 7, a perspective view of the top of the custom sole of the present invention is shown. This view shows at least one terminal slot 110, plurality of raised bumps 111, and top custom sole 103. As mentioned before, at least one terminal slot 110 is used to receive at least one terminal 113, and plurality of raised bumps correspond to whatever plurality of motors 116 (See FIG. 8) have been chosen by the user. Referring to FIG. 8, a perspective view of the top and bottom of the custom sole of the present invention is presented. Shown here are bottom custom sole 102, top custom sole 103, at least one terminal slot 110, plurality of raised bumps 111, and plurality of motors 116. As can be seen, top of custom sole 103 and bottom of custom sole 102 are shaped complimentarily. This allows for them to be properly aligned not only with each other, but with the rest of the present invention. The relative position of plurality of raised bumps 111 and plurality of motors 116 should be noted. This is because in a preferred embodiments, plurality of raised bumps 111 house plurality of motors 116.

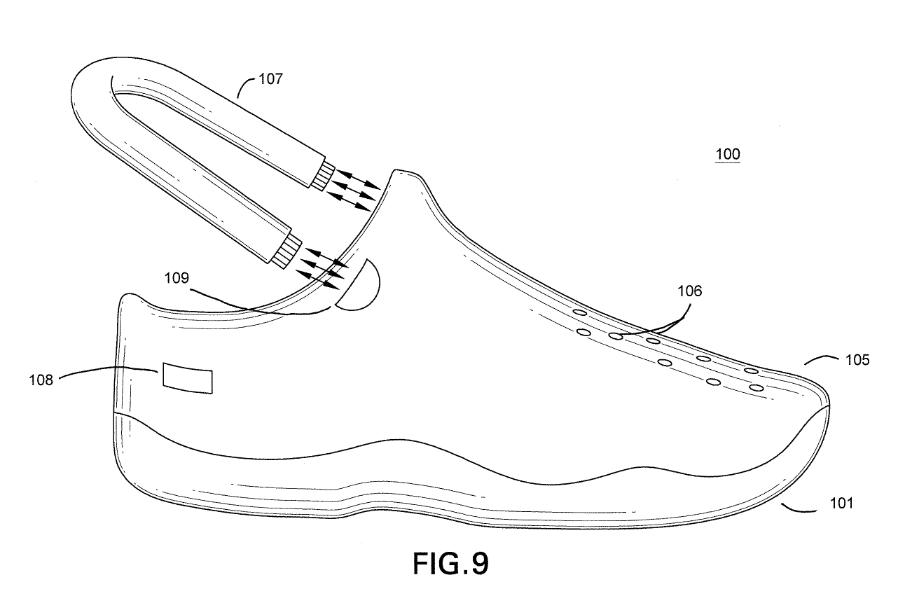

In FIG. 9 a side view of an embodiment of the present invention, highlighting the detachable nature of the strap is shown. This view shows vibrating foot massager 100, plurality of holes 106, top portion 105, bottom portion 101, strap 107, connection mechanism 109, and power switch 108. This view shows a preferred embodiment, wherein strap 107 is detachable. This is beneficial because in another preferred embodiment, the power source of the present device is contained in strap 107. By strap 107 being detachable, a plurality of recharging options can be provided. For example, strap 107 could be charged via an inductive mat or via solar energy. Further, the present invention could be comprised of multiple straps, allowing a user to have one strap charging while the other is in use.

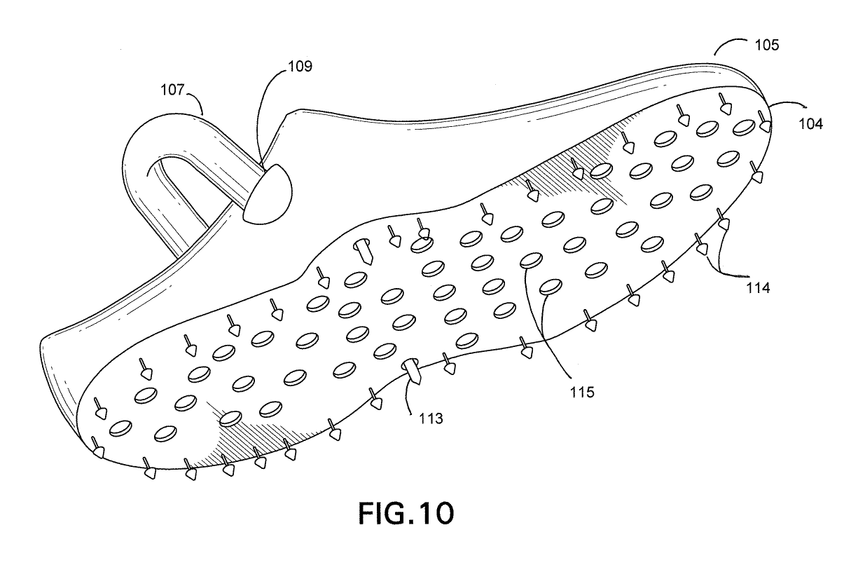

Connection mechanism 109 is in electronic communication with at least one terminal 113 (See FIG. 10), allowing the power source contained in strap 107 to be in electrical communication with a plurality of motors 116. In yet another preferred embodiment, strap 107 is capable of utilizing self-contained batteries to power the present invention. Preferably, these are AA batteries, although the strap can be shaped to accommodate batteries of other sizes.

In various embodiments, strap 107 can have a number of different lengths to accommodate users of various sizes, and to provide for a variety of battery capacities. Further, in a preferred embodiment, strap 107 is adjustable such that it may adjust to the size of a wide variety of users.

Referring to FIG. 10, a bottom perspective view of the top portion and interfacing sole of the present invention is shown. Of note here is the interaction between inter-facing sole 104 and top portion 105. Also shown are a plurality of motor slots 115, at least one terminal 113, and a plurality of pegs 114. Here, at least one terminal 113 is shown protruding through interfacing sole 104.

In one embodiment of the present invention, the vibrating motors are controlled via a software application. In a preferred embodiment, this software application indicates to a user what areas are being massaged and which pressure points are being engaged. Further, this software can track a user's use of the present invention and remind them to stimulate areas that they have been neglecting. This software application may also toggle the power and heat (if equipped) in the sandal of the present invention.

In a preferred embodiment, the body weight of a user will not stop the plurality of motors from vibrating because they are encased in bottom of custom sole 102. In some embodiments, the body weight of a user will not stop the plurality of motors from vibrating due to the motors being encased in a metal cap or a shell, as well as the fact that the plurality of raised bumps provides additional protection.

In another preferred embodiment, the plurality of motors will be connected to each other via electrical wiring. Alternatively, the plurality of motors could be connected via a printed circuit board. In an exemplary embodiment, the plurality of vibrating motors are recharged by the motion of the user walking around wearing the present invention. For example, the mechanism employed could be similar to that of an automatic watch.

In yet another embodiment, the top portion of the present invention can be comprised of fabric. In another embodiment, the present invention is equipped with a wireless transceiver, allowing it to be in electronic communication via an air interface with other similarly equipped proximate electronic devices.

In another embodiment, the present invention employs shockwaves to induce the electronic stimulation of a given muscle within a user. In this embodiment the frequency and strength of the stimulation can be controlled by the user. In yet another embodiment, the strap of the present invention is adorned with a plurality of LED's, preferably to be used in conjunction with product branding.

In alternative embodiments, the technology employed in the shoe of the present invention can be incorporated into pants, shirts, socks, and gloves. For example, a pants implementation may be sport pants with micromotor gel cups or patches that can be removed and placed into many different areas on the outside of the pants. These micromotors may be incorporated into gel cups or gel-like patches that generate heat. In one embodiment, such patches can be held together by lightweight magnets. The battery may be placed at any convenient location, for example on the bottom of each leg and rest around the ankle. The pants can be lined with a material that does not stick to a user's skin. In a preferred embodiment, a shirt implementation operates in a manner similar to that of the aforementioned pants with the exception that the battery is placed around a user's wrist, neck, or upper arm. An implementation of the present invention as socks can massage a user's feet with a combination of micromotors and micro beads.

Garment implementations can be constructed out of a stretchy rubber- or neoprene-containing material. With micro bead patches placed in specific areas of the sock or other garment, a user may have the comfort of soft micro beads and the vibrations of the micro motors hitting their foot or other body parts. The battery can be placed at any convenient location, for example, on the sock or pant leg wrapping around the ankle, or on the glove or shirt sleeve wrapping around the wrist. In some embodiments, the micromotors of the present invention are removable, for example for removal prior to washing the garment.

The present disclosure also contemplates a neoprene sport shirt that massages the torso of the user's body including the arms and back, using micro motors that are encased in gel beads that are in a form of cups or patches specifically placed to hit many areas. In an embodiment, a battery can be located around each of a user's wrist, and can be equipped with a power button. In embodiments, these gel patches can be removed and placed where desired.

In embodiments, a plurality of motors may be configured to be movable within a predetermined range in a garment. Alternatively or in addition, a plurality of motors may be fixed at select locations to provide stimulation to desired points or areas.

In another embodiment, the present invention can include heating elements for warming a user's body, for example, to provide therapeutic heating similar to a heating pad.

In embodiments, micromotors are embedded within or otherwise attached to tight-fitting garments such as compressions shirts, pants, socks, gloves, sleeves, headbands, and the like. As before, a variety of motors are suitable for this purpose, the appropriateness of said motors being determined by the force of the vibration desired as well as the size of the area being treated. Different combinations of vibrating motors allow for a wide range of customizability in how the user's body is affected. Additionally, motors can be immovably embedded, or removably attached to garments, such as using hook and loop connectors, to be readily substitutable and rearrangeable, making it easy to reconfigure the device.

In embodiments, garments can be provided with pads in which a plurality of coin motors may be placed, that can be movably attached to a garment to change the location of the coin motors and the user's body area they affect. A power source is included in the garment with a conveniently placed power switch allows a user to conveniently operate the present invention. Preferably, the power source is a rechargeable electrochemical cell.

In embodiments, the garment can be provided with a plurality of enclosures suitable to hold individual motors or arrays of motors. Coin motors that can be conveniently coupled thereto can be sold separately. This packaging allows a user to purchase a number of different garments configured to accommodate the same coin motors or arrays, depending on what area of the body a user would like to stimulate. A plurality of pad designs, each having a plurality of motor slots operatively coupled to at least one terminal, can be configured to be populated with motors, and can be attached to the different garments. Accordingly, individual ones or a plurality of motor slots can be utilized to hold coin motors. At least one terminal is used as a conduit from the power source, wherein said conduit is mediated by a power switch. Hook and loop connectors, magnets, or other coupling arrangements are used to secure populated pads to garments.

A connection mechanism such as a male/female plug arrangement provides for electrical communication with one or more terminals, allowing the power source contained in the garment to be in electrical communication with a plurality of motors. The power source can be replaceable batteries that may be rechargeable to power the present invention. The batteries can be any convenient standard size, or may be customized for use with the disclosed garments.

In embodiments, the vibrating motors are controlled via a software application. The software application can be used for a variety of functions, for example, to indicate to a user what areas are being massaged and which pressure points or meridians are being engaged. Further, this software can track a user's use of the present invention and remind them to stimulate areas that they have been neglecting. This software application may also toggle the power and heat (if equipped) in the garment of the present invention.

In embodiments, each of the motors is coupled to at least one other device via electrical wiring. Alternatively, the plurality of motors could be connected via a wiring harness. In another embodiment, the present invention employs small electrical shocks to stimulate a given muscle of a user. In this embodiment the frequency, strength, and waveform of the electrical stimulation can be controlled by the user. For example, a physical controller can be provided in the garment to allow a user to make such selections. Alternatively, a soft controller can be included in an app running on a smartphone or other device comprising a processor coupled to a memory that stores instructions for implementing the controller. In embodiments, a solid state display, for example comprising a plurality of LCDs or LEDs, can be included in the garment to present information regarding the operation of the garment to the user.

The present disclosure also contemplates a neoprene sport shirt that massages the torso of the user's body, or a particular body part such as the user's arms or back, using micro motors that are encased in gel beads that are in a form of cups or patches specifically placed to hit many areas. In an embodiment, one battery can be located around each of a user's wrist and be equipped with a power button. In embodiments, these gel patches can be removed and placed where desired.

Other embodiments may be configured to address the needs of users with accessibility issues, or users who are hard of seeing or blind, or users who are hard of hearing or deaf, ora combination of these. In embodiments, sensors may be added to footwear or garments, and the sensed data may be communicated to the user via patterns of vibrations. For example, proximity sensors may be added to shoes or garments to sense that the distance between the user and an object is decreasing, such as when the user is approaching an obstacle like a wall, or when people are moving toward the user and are nearby. Such sensors may be disposed on the front, sides, and back of the footwear or garment, to give the user 360 degree situational awareness. Whenever an object within range of a proximity sensors is sensed, sensor data is sent to a tangible processor operatively coupled to a data storage device such as a memory. The processor and memory may be disposed within the garment, or operatively coupled to the garment. For example, they may be disposed in a portable device such as a smart phone, and may communicate with the garment through a wired or wireless interface. The memory stores code which, when executed on the processor, cause the processor to receive the sensed data, and process the data to generate a signal or text message based on the sensed data, and to convey the signal or message to the user. The signal or message is conveyed to the user using vibrating elements in the footwear or garment. For example, vibrating elements may send a specific vibration that is unique to the specific situation to warn the user of the sensed object and its distance and direction from the user. Or, a text message may be conveyed to the user via a code implemented using vibrations.

In embodiments, an app can be installed on a portable data processing device such as a smart phone or smart watch, carried by a user who is blind, or deaf, or both, to facilitate user communication with others nearby. For example, messages can be conveyed using a standard set of vibrations. The standard set of vibrations can include a coded “alphabet” that must be learned, such as Braille or Morse code, conveyed through vibrations of the coin motors placed in the compression garments and/or footwear. A microphone can receive verbal audio signals; a processor operatively coupled to the microphone can convert the audio signals to text using conventional speech-to-text software, and convey the converted text to the user via vibrations. In this way the user can understand what is being said without the speaker using sign language. The microphone may be disposed in, or operatively coupled to, a user's smart phone, smart watch, or other item containing a tangible processor operatively coupled to a memory in which the app has been installed. In embodiments, the standard set of vibrations may be customizable by the user, or by the person sending the message, or both.

Similarly, the same apparatus can be used with the same or a different software app for listening to music, wherein a user who is hearing impaired can have a unique interactive experience with the music.

In embodiments, tight-fitting wearable accessories, such as a sleeve to be worn on one or both arms and/or legs, or a strap to be worn around the torso, can incorporate the same technology as the disclosed compression garments and footwear. Such accessories can be inconspicuously worn under loose-fitting garments. They may also be made in a variety of colors, such as flesh-toned colors that will not be visible under clothing. Of course, other colors, patterns, or other graphics may alternatively or additionally be used.

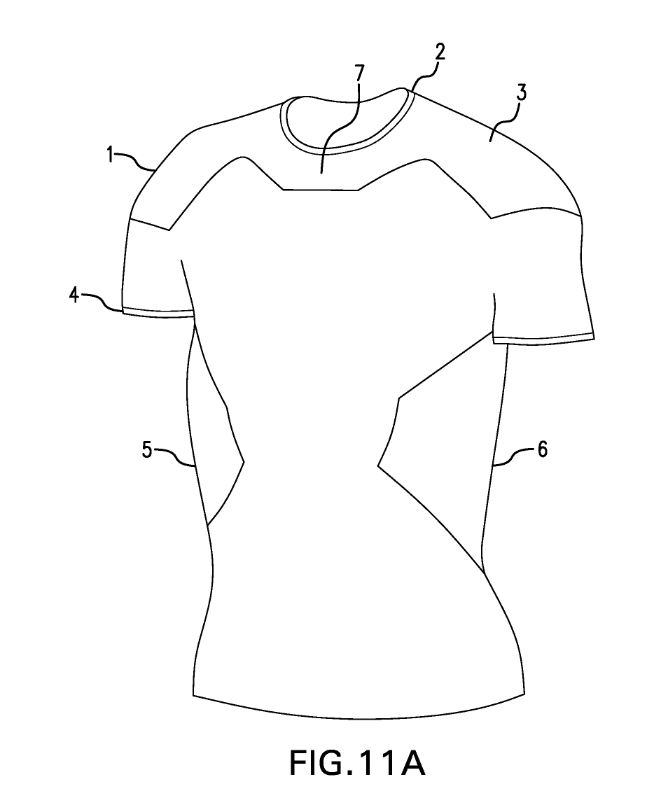

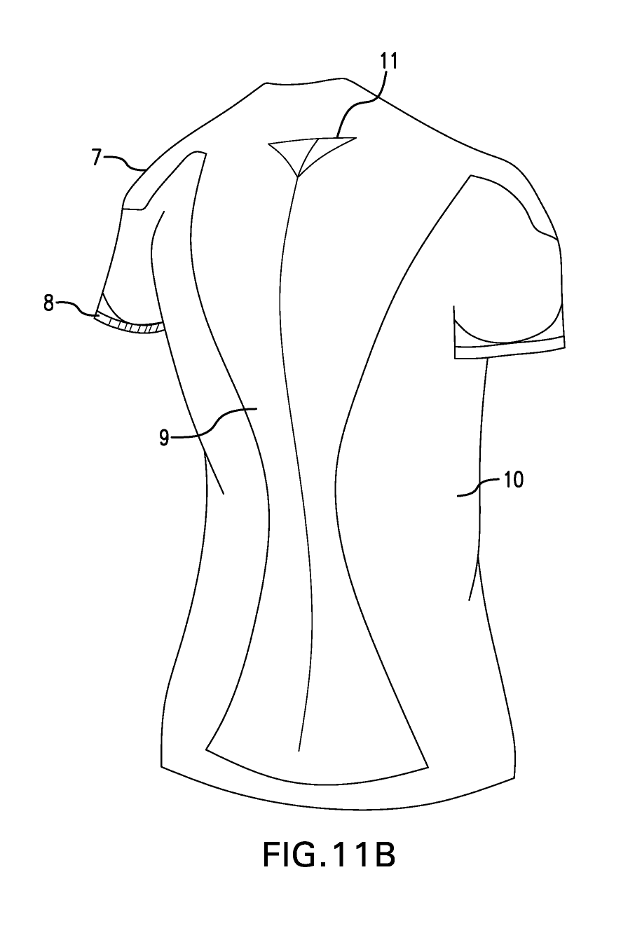

FIGS. 11A and 11B show an illustrative embodiment of a garment according to the disclosure, in this case a tight-fitting shirt, although other garments may be similarly constructed. FIG. 11A shows the front of the shirt and contains reference numerals 1-7. FIG. 11B shows the back of the shirt and contains reference numerals 7-11. In embodiments, micromotors are embedded in the fabric of the compression shirt in specific areas, such as on a wearer's deltoid, 1. In embodiments, one or more sensors may also be disposed within the garment, 2. In embodiments, one or more of the sensors may be placed in close proximity to one or more of the micromotors. Alternatively or in addition, one or more sensors may be spaced apart from the micromotors. In embodiments, padding is included in the garment, 3, and the micromotors and/or sensors may be embedded in the padding. Moreover, in addition to the motors and/or sensors themselves, wiring that couples them to a power source may be embedded in the padding, or in the fabric of the garment, or both. In embodiments, the wiring couples the micromotors and sensors to a power source via one or more terminals disposed within or proximate the padding containing the devices, or within the garment fabric proximate the devices, and/or proximate a battery.

One or more batteries may be configured to be located at any convenient place in the garment. As shown in FIGS. 11A and 11B, a battery is disposed in one or both of the arm holes, 4, 8, although other locations can also or alternatively be used. The battery may, but need not be, shaped to accommodate its placement. For example, batteries at the arm holes may be shaped as rings or arcs to mimic the shape of the arm that passes through the arm hole. Each battery is coupled to a terminal. The coupling may be detachable, such as using a male-female plug pair, or the battery and terminal(s) may be permanently coupled. Each terminal may be coupled more than one device in the garment. Devices coupled to a terminal may be of one type, or may include different types of devices, including but not limited to micromotors, sensors, heating elements, a processor coupled to a memory, or combinations of these.

In embodiments devices such as micromotors and sensors can be housed in padding, 5. In embodiments, a plurality of motors can be disposed throughout a predetermined area, in a predetermined or user selected pattern. A plurality of micromotors may be operated simultaneously to provide vibrational stimulation to an entire area. Alternatively or in addition, micromotors may be energized in a predetermined or user selected or programmed sequence. For example, an array of micromotors may be programmed to vibrate in one or more particular patterns, such as a dynamic vibrating pattern emanating outward in concentric circles from a center of the array, or a dynamic vibrating line that passes from one side of the array to another. These and other patterns may be pre-programmed and/or selected by a wearer to provide a desired therapeutic experience.

In embodiments, micromotors, sensors, heating elements, or combinations of these can be dispersed in regular or irregular patterns over one or more wide areas of the garment. In the embodiment illustrated in FIGS. 11A and 11B for example, micromotors may be placed in the garment to cover the obliques, 5, 6, or over the top of the torso, 7. Other areas may be additionally or alternatively be provided with patterns of devices.

In the illustrated embodiment, a plurality of micromotors are located running along the spine, 9. Alternatively or in addition, a plurality of micromotors can be disposed along the muscles adjacent to one or both sides of the spine. Any or all of these may be configured to vibrate in unison, or in any desired pattern. In embodiments, patterns and sequences can be run repetitively, for example in sequence from the top to the bottom of the spine, then jumping directly back to the top and in sequence to the bottom again. Or a pattern may be run forward and backward in repeated sequence, such as from top of the spine to the bottom, to the top, to the bottom, etc. A sequence can be run slowly, or quickly, at a preprogrammed or user selected speed.

As noted, more than one battery can be disposed at predetermined or user-selected locations in the garment. For example in the illustrated embodiment, a second battery is housed in the garment at the upper portion of the back, 11. In addition, other hardware may be operatively coupled to the battery, and may be co-located with the battery or spaced apart from it, including but not limited to a radio frequency (RF) transceiver like Bluetooth, a processor coupled to a memory, a motherboard on which other components are installed, and the like, which together execute the functionality of the suit.

As before disclosed, each of the micromotors provides therapeutic vibration to the garment wearer's body at the location of the micromotor(s). In addition, vibrating micromotors may be disposed at reflexology, acupressure and/or acupuncture points and meridians to stimulate those points and meridians.

In embodiments, the micromotors can be moved by the user to different locations in the garment to affect user-selected points, such as to relieve pain, muscle fiber tears, soreness, to stimulate blood flow, and the like. In embodiments, the micromotors are detachable from the garment, to remove them before washing for example. In embodiments, at least some of the micromotors may be permanently affixed to the garment.

In the various embodiments, the present invention, in part or in whole, can be constructed out of a material comprising one or more of rubber, foam, plastic, croslite, polyurethane, polyurethane foam, vinyl, and neoprene.

When introducing elements of the present disclosure or the embodiment(s) thereof, the articles “a,” “an,” and “the” are intended to mean that there are one or more of the elements. Similarly, the adjective “another,” when used to introduce an element, is intended to mean one or more elements. The terms “including” and “having” are intended to be inclusive such that there may be additional elements other than the listed elements.

While the disclosure refers to exemplary embodiments, it will be understood by those skilled in the art that various changes may be made and equivalents may be substituted for elements thereof without departing from the scope of the disclosure. In addition, many modifications will be appreciated by those skilled in the art to adapt a particular instrument, situation or material to the teachings of the disclosure without departing from the spirit thereof. Therefore, it is intended that the disclosure not be limited to the particular embodiments disclosed.

What is claimed is:

1. A massaging compression garment, comprising:
a garment body having an inside surface and an outside surface, the garment body comprising a stretchy textile;
a plurality of coin vibration motors coupled to the inside surface of the garment body;
a battery coupled to the inside surface of the garment body and electrically coupled to the coin vibration motors;
a power switch coupled to the garment body and electrically coupled to the battery and configured to control the flow of power from the battery to the coin vibration motors to cause them to vibrate.

2. The massaging compression garment of claim 1, wherein the motors, battery, and power switch are removably coupled to the garment body.

3. The massaging compression garment of claim 1, wherein the motors and the inside surface of the garment are configured and arranged so at least a portion of the motors can be disposed at select ones of a plurality of locations.

4. The massaging compression garment of claim 1, wherein at least a portion of the stretchy textile comprises a material selected from the group consisting of: rubber, foam, plastic, croslite, polyurethane, polyurethane foam, vinyl, and neoprene.

5. The massaging compression garment of claim 1, wherein the garment body further comprises at least one pad configured and arranged to securely hold a plurality of the coin motors.

6. The massaging compression garment of claim 1, further comprising at least one pad removably attached to the garment body and configured and arranged to securely hold a plurality of the coin motors.

7. The massaging compression garment of claim 1, wherein at least a portion of the motors, battery, and power switch are removably coupled to the garment body using magnets.

8. The massaging compression garment of claim 1, wherein at least a portion of the motors, battery, and power switch are removably coupled to the garment body using hook and loop connectors.

9. The massaging compression garment of claim 1, wherein the battery is of a standard size and construction.

10. The massaging compression garment of claim 1, wherein the battery is a rechargeable battery.

11. The massaging compression garment of claim 10, wherein the battery is removable and wirelessly rechargeable.

12. The massaging compression garment of claim 1, further comprising a plurality of sensors coupled to the garment and electrically coupled to the battery.

13. The massaging compression garment of claim 12, wherein at least a portion of the sensors are proximity sensors arranged to provide 360 degree situational awareness to a wearer of the garment.

14. The massaging compression garment of claim 12, further comprising a tangible processor communicatively coupled to the sensors, and operatively coupled to a memory that stores processor readable and executable code.

15. The massaging compression garment of claim 14, wherein the processor receives proximity data from the proximity sensors, analyzes the data to determine at least one of a range and a direction to a sensed object, and sends signals to at least a portion of the coin motors to vibrate in accordance with a predetermined vibrational scheme to convey the range and/or the direction from a predetermined position on the garment.

16. The massaging compression garment of claim 12, further comprising at least one microphone communicatively coupled to the processor, that receives verbal audio signals, converts them to electrical signals, and sends the electrical signals to the processor.

17. The massaging compression garment of claim 16, wherein the processor analyzes the electrical signals, converts the electrical signals to text based on the analysis, and uses the text to generate a message to be conveyed to the wearer of the garment.

18. The massaging compression garment of claim 17, wherein the processor causes at least a portion of the coin motors to vibrate in accordance with a code comprising vibrational patterns that represent textual symbols, to convey the message.

19. The massaging compression garment of claim 18, wherein the code comprises at least one of Morse code and Braille.

20. The massaging compression garment of claim 16, wherein the microphone receives audio signals containing music, and wherein the processor causes at least a portion of the coin motors to vibrate in a manner that conveys to the wearer of the garment a tactile experience based on the music.
